(19) United States
(12) Patent Application Publication
(10) Pub. No.: US 2011/0010209 A1
(43) Pub. Date: Jan. 13, 2011

(54) STATISTICAL CONDITION DETECTION AND RESOLUTION MANAGEMENT

(75) Inventor: John H. McNally, Southbury, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/499,847

(22) Filed: Jul. 9, 2009

(51) Int. Cl. G06Q 10/00; G06F 15/18; G06N 5/02

(52) U.S. Cl. 705/7; 706/12; 706/47

(57) ABSTRACT

A statistical condition detection and resolution management method includes sampling data and performing statistical analysis on the sampled data, the sampled data representing events detected by an event profiling engine. The method also includes generating, a profile from results of the statistical analysis, the profile indicating a normative value of an attribute identified in the sampled data, and any outliers identified in the sampled data. Upon discovering an outlier, the method includes creating, via a rule engine in communication with the event profiling engine, a rule that defines an action to be taken for a condition identified as a result of the statistical analysis, and monitoring, via an event processing engine in communication with the rule engine, real-time operational data corresponding to attributes of the profile. When in response to the monitoring the condition is met, the method includes implementing the action identified in the rule.

### BACKGROUND

The present disclosure relates generally to process controls monitoring and, in particular, to statistical condition detection and resolution management using complex event processing techniques.

The ability of an entity (e.g., a commercial enterprise) to succeed in its environment depends, in part, on its ability to accurately define appropriate rules of conduct (e.g., rules against overstating revenue or profit, or fraudulently claiming benefits of business transactions), and establish and administer controls such that violations of the rules are quickly and efficiently discovered and corrected. Existing tools, such as entity profiling management systems offer some support in identifying various conditions that are candidates for monitoring. Typically, these systems receive pre-defined conditions subject to monitoring (e.g., payments made which exceed $500 are considered suspect), such that the system processes payment data looking for values that exceed $500. A rules-based event processing engine (e.g., complex event processor) may then be directed to search one or more databases (e.g., transactional database) for this condition using the prescribed rule to identify possible violations, risks, or other defined factors. Thus, the entity profiling management system facilitates the monitoring and identification of conditions based upon pre-established condition definitions (implemented, e.g., via a data structure customized for the particular condition).

However, during the ordinary course of its operations, there may be many “unknown” risk factors or conditions, of which the entity is unaware (i.e., one cannot “find” something that one does not “know to look for”). As a result, such conditions would go unnoticed and, consequently, unaddressed or unresolved.

What is needed, therefore, is an integrated system and method to discover conditions or factors that are not necessarily known to exist by the entity (i.e., previously unidentified), and using these conditions or factors to monitor, detect, and resolve future incidences of various events resulting from the occurrence of these conditions.

### BRIEF SUMMARY

Embodiments of the invention include methods for statistical condition detection and resolution management. A method includes sampling data and performing statistical analysis on the sampled data, the sampled data representing events detected by an event profiling engine. The method also includes generating, via the event profiling engine, a profile from results of the statistical analysis. The profile indicates a normative value of an attribute identified in the sampled data and any outliers identified in the sampled data. Upon discovering an outlier in the sampled data, the method includes: creating, via a rule engine in communication with the event profiling engine, a rule that defines an action to be taken for a condition identified as a result of the statistical analysis; and monitoring, via an event processing engine in communication with the rule engine, real-time operational data corresponding to attributes of the profile. When, in response to the monitoring the condition is met, the method includes implementing the action identified in the rule.

Further embodiments include a system for statistical condition detection and resolution management. The system includes a host system and a risk management application and user interface executing on the host system. The risk management application includes an event profiling engine, a rule engine, an event processing engine, and a feedback engine. The application implements a method via the user interface. The method includes sampling data and performing statistical analysis on the sampled data, the sampled data representing events detected by the event profiling engine. The method also includes generating, via the event profiling engine, a profile from results of the statistical analysis, the profile indicating a normative value of at least one attribute identified in the sampled data and any outliers identified in the sampled data. Upon discovering an outlier in the sampled data via the event profiling engine, the method includes: creating, via the rule engine in communication with the event profiling engine, a rule that defines an action to be taken for a condition identified as a result of the statistical analysis; and monitoring, via the event processing engine in communication with the rule engine, real-time operational data corresponding to attributes of the profile. When, in response to the monitoring the condition is met, the method includes implementing the action identified in the rule via the event processing engine.

Further embodiments include a computer program product for statistical condition detection and resolution management. The computer program product includes a computer readable storage medium having computer readable program code embodied therewith, the computer readable program code configured to implement a method. The method includes sampling data and performing statistical analysis on the sampled data, the sampled data representing events. The method also includes generating a profile from results of the statistical analysis, the profile indicating a normative value of at least one attribute identified in the sampled data and any outliers identified in the sampled data. Upon discovering an outlier in the sampled data, the method includes: creating a rule that defines an action to be taken for a condition identified as a result of the statistical analysis; and monitoring real-time operational data corresponding to attributes of the profile. When, in response to the monitoring the condition is met, the method includes implementing the action identified in the rule.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a portion of system upon which statistical condition detection and resolution management functions may be implemented in exemplary embodiments;

FIG. 2 is a flow diagram describing a process for implementing statistical condition detection and resolution management in accordance with exemplary embodiments; and

FIG. 3 is a computer screen, window or display depicting a user interface with sample data produced via the statistical condition detection and resolution management functions in exemplary embodiments.

The detailed description explains the preferred embodiments of the invention, together with advantages and features, by way of example with reference to the drawings.

### DETAILED DESCRIPTION

Methods, systems, and computer program products for statistical condition detection and resolution management are provided in exemplary embodiments. In a controls process environment, the statistical condition detection and resolution management functions provide an integrated system and method to discover conditions or factors that are not necessarily known to exist (i.e., previously unidentified) by an entity of the controls process environment, and uses these conditions or factors to monitor, detect, and resolve future incidences of various events resulting from the occurrence of these conditions.

The features described herein provide a disciplined approach to statistical condition detection and resolution management, including providing an integrated platform that seamlessly facilitates statistical condition detection, auto generation of rules based upon the conditions detected, application of the rules to real-time or near real-time operational data, issue resolution processes defined by the rules, and updates to the statistical detection, rule generation, and issue resolution management processes based upon results of the above processes.

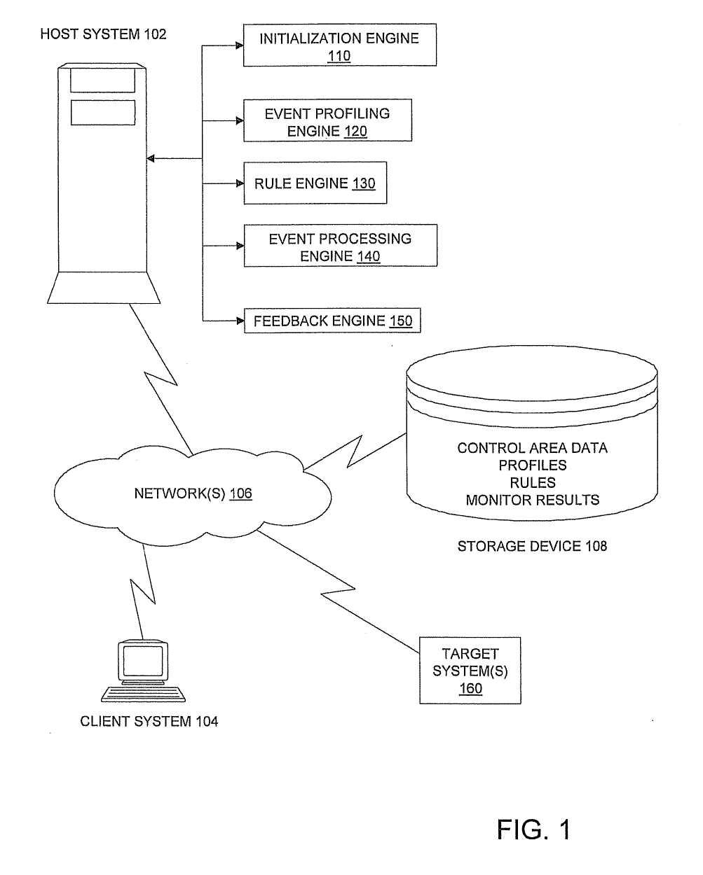

Referring now to FIG. 1, a host system 102 executes computer instructions for performing statistical condition detection and resolution management. Host system 102 may operate in any type of environment that seeks to monitor operational data and identify/resolve potential issues resulting therefrom. For example, the type of data subject to monitoring may include transactional data, telemetry, and instrumentation output, to name a few. Host system 102 may comprise a high-speed computer processing device, such as a mainframe computer, to manage the volume of operations governed by an entity for which the statistical condition detection and resolution management activities are performed. In one exemplary embodiment, the host system 102 may be part of an enterprise (e.g., a commercial business) that implements the statistical condition detection and resolution management functions on its own operational data. Alternatively, the host system 102 may be implemented by an application service provider that provides the statistical condition detection and resolution management functions on behalf of an organization or enterprise as a service to the entity.

In an exemplary embodiment, the system depicted in FIG. 1 includes one or more client systems 104 through which users at one or more geographic locations may contact the host system 102. The client systems 104 are coupled to the host system 102 via one or more networks 106. Each client system 104 may be implemented using a general-purpose computer executing a computer program for carrying out the processes described herein. The client systems 104 may be personal computers (e.g., a lap top, a personal digital assistant) or host attached terminals. If the client systems 104 are personal computers, the processing described herein may be shared by a client system 104 and the host system 102 (e.g., by providing an applet to the client system 104). Client systems 104 may be operated by authorized users of the statistical condition detection and resolution management services described herein.

In an exemplary embodiment, the system depicted in FIG. 1 includes one or more target systems 160 through which users at one or more geographic locations may contact the host system 102. Target systems 160 may represent external entities that communicate with the host system 102 to receive alerts, assist in directing one or more actions to be taken upon the occurrence of specified conditions, and provide various related communications with the host system 102 as described further herein. The target systems 160 may be coupled to the host system 102 via one or more networks 106. Each target system 160 may be implemented using a general-purpose computer executing a computer program for carrying out the processes described herein. The target systems 160 may be personal computers (e.g., a lap top, a personal digital assistant) or host attached terminals. If the target systems 160 are personal computers, the processing described herein may be shared by a target system 160 and the host system 102 (e.g., by providing an applet to the target system 160). Target systems 160 may be operated by authorized users of the statistical condition detection and resolution management services described herein

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. A client system 104 may be coupled to the host system 102 through multiple networks (e.g., intranet and Internet) so that not all client systems 104 are coupled to the host system 102 through the same network. One or more of the client systems 104 and the host system 102 may be connected to the networks 106 in a wireless fashion. In one embodiment, the networks include an intranet and one or more client systems 104 execute a user interface application (e.g. a web browser) to contact the host system 102 through the networks 106. In another exemplary embodiment, the client system 104 is connected directly (i.e., not through the networks 106) to the host system 102 and the host system 104 contains memory for storing data in support of the statistical condition detection and resolution management functions. Alternatively, a separate storage device (e.g., storage device 108) may be implemented for this purpose.

The storage device 108 includes a data repository (also referred to herein as a datastore) with data relating to operational data of an entity subject to the statistical condition detection and resolution management functions. The storage device 108 is logically addressable as a consolidated data source across a distributed environment that includes networks 106. Information stored in the storage device 108 may be retrieved and manipulated via the host system 102, the client systems 104, and/or the target systems 160. The data repository includes one or more databases containing, e.g., control area definitions, profiles, rules, feedback results of monitoring and actions taken, and other related information. In an exemplary embodiment, a control area definition specifies data identified for use in describing a potential control, and includes a time span and scope of the data subject to the control. A control area may refer to a domain of data subject to statistical analysis as defined by pre-determined criteria including, e.g., time of periods of sampling and scope of the domain. The control area may be defined in response to a decision by an entity to investigate a potential for key controls driven by various factors, such as legal (Sarbanes/Oxley, local legal mandate, etc.), business (application maintenance costs exceed expected levels), and other desired focus areas. A control area definition may be input to an initialization engine 110 of the condition detection and resolution management system as will be described further herein. Profiles include results of statistical analysis of events gathered from process data defined by the control area. These events may be “post-occurrence” events and/or “real-time” events. In one exemplary embodiment, post-occurrence events refer to data that are associated with one or more detectable events as a result of data sampling processes performed on historical data files (e.g., as opposed to real-time monitoring of data). By contrast, real-time events refer to data associated with one or more detectable events as a result of data sampling process performed on live data streams (e.g., network bandwidth or processor speed measurements). The profiles are generated by an event profiling engine 120 of the condition detection and resolution management system. In an exemplary embodiment, a profile indicates a normative value of at least one attribute or aspect identified in the sampled data, as well as any outliers identified in the sampled data. The storage device 108 also stores rules created by a rules engine 140. In an exemplary embodiment, a rule defines one or more actions to be taken for a condition identified as a result of the statistical analysis, and which has manifested during monitoring of the real time operations. Results of monitoring operations, as well as actions taken in response to monitoring, are stored in the storage device 108.

The host system 102 depicted in the system of FIG. 1 may be implemented using one or more servers operating in response to a computer program stored in a storage medium accessible by the server. The host system 102 may operate as a network server (e.g., a web server) to communicate with the client systems 104. The host system 102 handles sending and receiving information to and from the client systems 104 and can perform associated tasks. The host system 102 may also include a firewall to prevent unauthorized access to the host system 102 and enforce any limitations on authorized access. For instance, an administrator may have access to the entire system and have authority to modify portions of the system. A firewall may be implemented using conventional hardware and/or software as is known in the art.

The host system 102 may also operate as an application server. The host system 102 executes one or more computer programs to provide statistical condition detection and resolution management functions. These one or more applications are collectively referred to herein as a condition detection and resolution management system and user interface. As indicated above, processing may be shared by the client systems 104 and the host system 102 by providing an application (e.g., java applet) to the client systems 104. Alternatively, the client system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

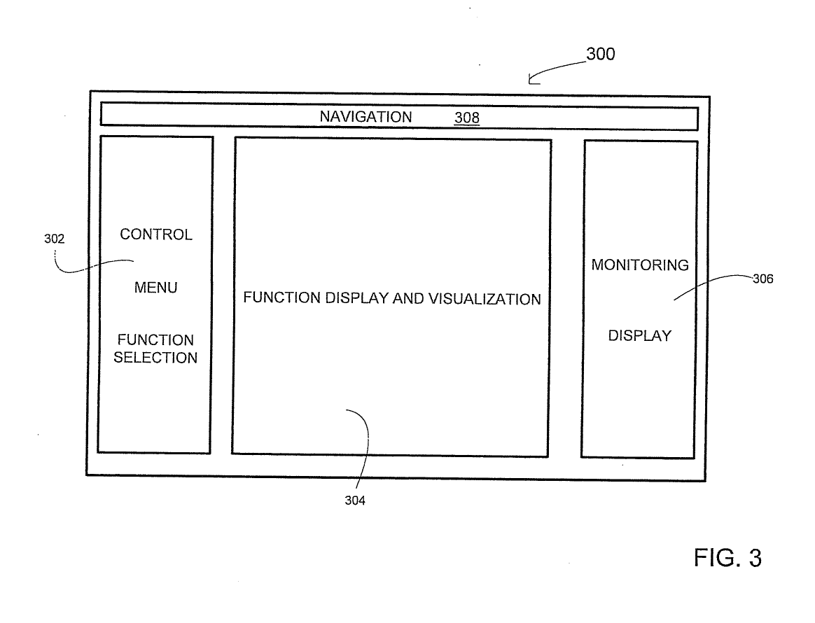

The condition detection and resolution management system implements statistical condition detection and resolution management activities as described herein. In an exemplary embodiment, the condition detection and resolution management system is implemented by an initialization engine 110, an event profiling engine 120, a rule engine 130, an event processing engine 140, and a feedback engine 150. While shown as separate components of the condition detection and resolution management system, it will be understood that one or more of engines 110-150 may be integrated as a single application and/or hardware elements on the host system 102. As indicated above, the condition detection and resolution management system may include a user interface for enabling one or more users (e.g., individuals of client systems 104) to enter criteria used by the condition detection and resolution management system as described herein. A sample computer screen window, or display, illustrating the user interface is shown and described in FIG. 3.

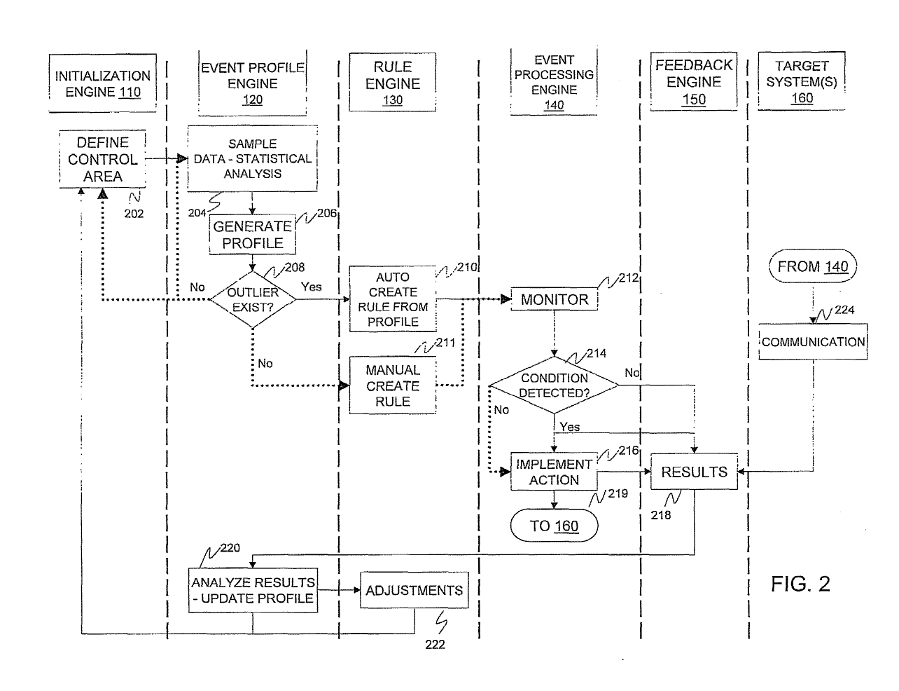

The engines 110-150 described in FIG. 1 may be implemented in hardware, software, or a combination thereof In an exemplary embodiment, initialization engine 110 provides the user interface that enables one or more users (e.g., client systems 104) to define a control area for study. As indicated above, the control area is configured to enable the user to set parameters (time, scope, etc.) for which data will be subject to statistical analysis. Event profiling engine 120 is configured to sample the data subject to the control area and perform statistical analysis on the sampled data. In one exemplary embodiment, the data defined by the control area is stored in storage device 108 and sampled by the event profiling engine 120. Alternatively, or in addition thereto, live data streams may be subject to the control area definition and sampled by the event profiling engine 120. Once gathered, the statistical analysis may be configured to identify “expected” behaviors (e.g., using Pareto Frontier or other analysis tools) of the data, as well as any outliers or anomalies. A profile is generated that reflects the results of the statistical analysis. For example, a profile may specify that for 1,000 samples taken, instances of attribute A fall within some measurable range of 50 more than 95% of the time, and instances of attribute B fall within another measurable range 30 more than 99% of the time. It is understood that A then falls outside of the specified range 5% of the time, while B falls outside of its specified range 1% of the time. In a transaction-based environment, measurable attributes may include, e.g., money values, dates, names, account numbers, or any other measurable element. One example of measurable attributes for a live data stream may include, e.g., data rates, error rates, etc. used in monitoring computer or computer network performance. In an exemplary embodiment, rule engine 130 receives the results of the statistical analysis from engine 120, i.e., the profile(s), and automatically creates one or more rules based upon these results, and the rules are applied to real-time operational data as described herein. Event processing engine 140 monitors operational data in real time or near real time and applies the rules received from the rule engine 130 to the operational data. Feedback engine 150 receives results from both monitoring and actions taken in response to the monitoring, and delivers the results to the appropriate engine (e.g., to the event processing engine 140 and/or the event profiling engine 120). The event profiling engine 120 may be implemented as a plug-in to an existing product, such as an event profile management system (EPMS), and which is enhanced with statistical analysis and visualization components. The rule engine 130 may be implemented, e.g., using analytical processes in conjunction with a structured query language that conforms to the format implemented by a database management system of the storage device 108. The event processing engine 140 may be implemented as a plug-in to an existing product, such as a complex event processing engine (CEPE), and is enhanced with components that receive and act on information received from rule engine 130, as well as target systems 160 and feedback engine 150 (e.g., via Message Broker). In an exemplary embodiment, feedback engine 150 sits logically between event profiling engine 120 and event processing engine 150, as will be described further in FIG. 2.

Turning now to FIG. 2, an exemplary process for implementing the condition detection and resolution management system will now be described.

At step 202, a user (e.g., client system 104) defines a control area subject to data sampling by identifying data associated with the control area and selecting a time span and scope of the data sampling. This may be implemented by the initialization engine 110 via a user interface of the condition detection and resolution management system. A sample user interface window or display is shown and described in FIG. 3. In one exemplary embodiment, if the statistical analysis is to be performed on post-occurrence events, the data subject to the control area definition is identified, in part, by its storage location in the datastore 108. In an alternate exemplary embodiment, if the statistical analysis is to be performed on real-time events, the data subject to the control area definition is identified, in part, by its source, or communication pathway.

At step 204, the event profiling engine 120 samples the control area data from the datastore, and/or the live data stream, and performs statistical analysis on the sampled data. As indicated above, this sampled data, and the data defined by the control area, represent post-occurrence events and/or real-time events, respectively, detected by the event profiling engine 120.

At step 206, the event profiling engine 120 generates a profile from results of the statistical analysis. In an exemplary embodiment, the profile indicates a normative value of at least one attribute identified in the sampled data, as well as any outliers identified in the sampled data.

At step 208, the event profiling engine 120 determines whether any outliers have been discovered as a result of the statistical analysis. If not, this could mean that the control area defined has few or no issues that might be considered relevant for monitoring (e.g., all values are normative indicating no issues with the sampled data). If there are no outliers in the sampled data, the process may return to the initialization engine 110, whereby the control area may be further defined (e.g., to increase, or otherwise modify, the domain of data sampled). Otherwise, if no outliers exist at step 208, the user may optionally manually create a rule for the control area definition via the rule engine 130, which is then transmitted to the event processing engine 140.

If, however, any outliers exist from step 208, the rule engine 130 uses the results of the statistical analysis to automatically generate one or more rules for application to real time operational data that correspond to the control area definition provided in step 202. Rule Engine 130 includes a component implemented as one or more programs which take in results of the statistical analysis in step 208 and create rules employed by the event processing engine 140. In step 210, the dimensions and attributes of the results of the analysis in steps 204-208 are analyzed and a rule is generated (e.g., detect relative or absolute amplitude of deviation from expected norm, frequency of occurrence, period or duration of occurrence, and lack of expected occurrence over time, to name a few) according to control interface requirements of the event processing engine 140. Logic included in the rule engine 130 may take into account factors, such as heuristic or experiential influence (e.g., damping, buffering, artificial intelligence, and machine learning) to prevent rapid cycling, over-correcting, and/or over- or under-reacting to conditions when the rules created are executed in the event processing engine 140 (e.g., defensive weapons system over-corrects and misses the target, bank fraud detection alerts on all ATM transactions, audit system fails to alert). Manual adjustments to the creation of rules are enabled via commands accepted through the user interface (see, FIG. 3, e.g., panes 302 and 304). Projected/estimated results may be viewed via the user interface (see FIG. 3, e.g., pane 306). Adjustments from step 222 may be incorporated by the rule engine 130 logic to adjust detection of occurrences/complex events to the desired sensitivity, as described further in FIG. 2. As indicated above, the rules define one or more actions to be taken for a condition identified as a result of the statistical analysis, and which has manifested during monitoring of the real time operations.

At step 212, the event processing engine 140, in communication with the rule engine 130, monitors real-time operations corresponding to attributes of the profile. At step 214, the event processing engine 140 determines if a condition of the rule(s) has been detected from the monitoring (e.g., outliers exist, or outliers with value outside of a rule-based threshold exist). If not, results of this non-detection may be provided to the feedback engine at step 218. Alternatively, or in conjunction therewith, if no condition has been detected, an action prescribed in the rule may be implemented at step 216. For example, a message indicating that no condition has been detected may be defined by the rule and transmitted to an entity (e.g., client system 104 and/or target system 160)(step 219). As indicated above, a target system 160 may represent external entities that communicate with the host system 102 to receive alerts, assist in directing one or more actions to be taken upon the occurrence of specified conditions, and provide various related communications with the host system 102. In this example, the message reflects the action to be taken.

If, however, at step 214, it is determined a condition has been detected (e.g., an outlier value that is outside of the profile), the results of the detection are provided to the feedback engine at step 218. Alternatively, and/or in conjunction therewith, an action specified in the rule in response to the detection may be implemented at step 216. As shown in FIG. 2, implementing the action may involve communications between the event processing engine 140 and one or more external target systems 160, based upon the nature of action required and/or result desired at step 224.

It will be understood that a rule may combine various conditions, such that the occurrence of one more conditions (e.g., a pattern of events) may be used to define the rule and actions taken. For example, if a condition is detected in step 214, it may be transmitted to the feedback engine (results) at step 218 and the process may return to step 212 whereby the event processing engine 140 continues to monitor for the condition as defined by the rule. In this example, the steps 212, 214, and 218 may be repeated until a pattern has been determined. In response to the pattern detection, one or more of steps 216, 218, and 219 may be performed. This pattern detection may be referred to as a complex event.

Once a result of the monitoring in step 212, and/or target system 160 communication in step 224, has been transmitted to the feedback engine 150 at step 218, the feedback engine 150 determines if the results of the monitoring (from steps 212-214) and/or action implemented (step 216) were successful based upon the objectives set forth in the rule.

At step 220, the event profiling engine 120 receives the results from the feedback engine 150, analyzes the efficacy of the applied rule, and adjusts one or more attributes of the profile and/or conditions of the rule(s), if appropriate, based upon results of the efficacy analysis at step 222. Thus, results of the monitoring and application of rules and actions taken may be used to update, modify, or regulate further control area definitions, profile definitions, and/or rules as a continuous controls loop process.

Turning now to FIG. 3, an exemplary user interface implemented via any visualization method such as, e.g., a computer screen window or virtual reality immersion 300 will now be described. The user interface represents a consolidated view of each of the profile/processing activities, as well as a control interface for the statistical condition detection and resolution management functions. The exemplary user interface window 300 includes a navigation bar (or tool bar) 308, and three panes 302, 304, and 306. The pane 302 provides options for selecting and executing system functions from a list of available functions (e.g., via a drop down menu or menu list). Pane 304 displays graphical representations of analysis, functions, adjustments, and/or controls including options to implement changes to rules based on user or administrator decisions, as determined from selections made from pane 302. For example, manual adjustments to the creation of rules may be implemented via panes 302 and 304, as described above in FIG. 2 (e.g., from step 222). Pane 306 displays visualization of activities and performance of the event profile engine 120, rule engine 130, event processing engine 140, feedback engine 150, and target systems 160, as determined from selections made from pane 302. For example, projected/estimated results of the statistical analysis, condition detection and monitoring, and/or actions taken may be viewed, e.g., as a graphical depiction, in pane 306, as described above in FIG. 2.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for statistical condition detection and resolution management, comprising:
sampling data and performing statistical analysis on the sampled data, the sampled data representing events detected by an event profiling engine;
generating, via the event profiling engine, a profile from results of the statistical analysis, the profile indicating a normative value of at least one attribute identified in the sampled data, and any outliers identified in the sampled data;
upon discovering an outlier in the sampled data:
creating, via a rule engine in communication with the event profiling engine, a rule that defines an action to be taken for a condition identified as a result of the statistical analysis; and
monitoring, via an event processing engine in communication with the rule engine, real-time operational data corresponding to attributes of the profile; and
when in response to the monitoring the condition is met, implementing the action identified in the rule.

2. The method of claim 1, further comprising defining a control area representing a domain of data subject to performing the statistical analysis, the control area defined via an initialization engine in communication with the event profile engine, the method further comprising:
transmitting results of implementing the action to a feedback engine;
determining whether the implemented action successfully met objectives set forth in the rule; and
transmitting results of the determining to the event profiling engine, the event profiling engine analyzing efficacy of the rule and adjusting, via the initialization engine, one or more attributes of the control area, if appropriate, based upon results of the efficacy analysis.

3. The method of claim 2, further comprising updating, via at least one of the initialization engine, event profiling engine, and rule engine, at least one criteria defined in the rule when it is determined that the implemented action is unsuccessful in meeting the objectives of the rule.

4. The method of claim 1, further comprising defining a control area representing a domain of data subject to performing the statistical analysis, the control area defined via an initialization engine in communication with the event profile engine, the method further comprising:
transmitting results of the monitoring to a feedback engine;
determining, via the feedback engine, whether the condition set in the rule has been met;
transmitting, via the feedback engine, results of the determining to the event profiling engine, the event profiling engine analyzing efficacy of the condition and adjusting, via the initialization engine, one or more attributes of the control area, if appropriate, based upon results of the efficacy analysis.

5. The method of claim 1, further comprising:
defining a control area representing a domain of data subject to performing the statistical analysis, the control area defined via an initialization engine in communication with the event profile engine;
wherein the domain of data comprises historical data in a data store.

6. The method of claim 1, further comprising:
defining a control area representing a domain of data subject to performing the statistical analysis, the control area defined via an initialization engine in communication with the event profile engine;
wherein the domain of data comprises a live data stream.

7. The method of claim 1, wherein the rule includes a directive to generate an alert when at least one of the condition is met and the action is implemented, the method further comprising:
generating and transmitting the alert to an entity defined in the rule when the at least one of the condition is met and the action has been implemented.

8. A system for providing statistical condition detection and resolution management, comprising:
a host system; and
a statistical condition detection and resolution management application and user interface executing on the host system, the statistical condition detection and resolution management application including an event profiling engine, a rule engine, an event processing engine, and a feedback engine, the application implementing a method via the user interface, comprising:
sampling data and performing statistical analysis on the sampled data, the sampled data representing events detected by the event profiling engine;
generating, via the event profiling engine, a profile from results of the statistical analysis, the profile indicating a normative value of at least one attribute identified in the sampled data, and any outliers identified in the sampled data;
upon discovering an outlier in the sampled data via the event profiling engine:
creating, via the rule engine in communication with the event profiling engine, a rule that defines an action to be taken for a condition identified as a result of the statistical analysis; and
monitoring, via the event processing engine in communication with the rule engine, real-time operational data corresponding to attributes of the profile; and
when in response to the monitoring the condition is met, implementing the action identified in the rule via the event processing engine.

9. The system of claim 8, wherein the application further includes an initialization engine and a feedback engine, the initialization engine defining a control area representing a domain of data subject to performing the statistical analysis;
wherein the event processing engine transmits results of implementing the action to the feedback engine, the feedback engine determines whether the implemented action successfully met objectives set forth in the rule, and transmits results of the determining to the event profiling engine;
wherein the event profiling engine analyzes efficacy of the rule and adjusts, via the initialization engine, one or more attributes of the control area, if appropriate, based upon results of the efficacy analysis.

10. The system of claim 9, wherein the application updates at least one criteria defined in the rule when it is determined that the implemented action is unsuccessful in meeting the objectives of the rule.

11. The system of claim 8, wherein the application further includes an initialization engine and a feedback engine, the initialization engine defining a control area representing a domain of data subject to performing the statistical analysis;
wherein the event processing engine transmits results of the monitoring to the feedback engine, the feedback engine determining whether the condition set in the rule has been met and transmits results of the determining to the event profiling engine;
wherein the event profiling engine analyzes efficacy of the condition and adjusts, via the initialization engine, one or more attributes of the control area, if appropriate, based upon results of the efficacy analysis.

12. The system of claim 8, wherein the application further includes an initialization engine, the initialization engine defining a control area representing a domain of data subject to performing the statistical analysis;
wherein the domain of data comprises historical data in a data store.

13. The system of claim 8, wherein the application further includes an initialization engine, the initialization engine defining a control area representing a domain of data subject to performing the statistical analysis;
wherein the domain of data comprises a live data stream.

14. The system of claim 8, wherein the rule includes a directive to generate an alert when at least one of the condition is met and the action is implemented;
wherein the event processing engine generates and transmits the alert to an entity defined in the rule when the at least one of the condition is met and the action has been implemented.

15. A computer program product for providing statistical condition detection and resolution management, the computer program product including a computer readable storage medium having computer readable program code embodied therewith, the computer readable program code configured to implement:
sampling data and performing statistical analysis on the sampled data, the sampled data representing events;
generating a profile from results of the statistical analysis, the profile indicating a normative value of at least one attribute identified in the sampled data, and any outliers identified in the sampled data;
upon discovering an outlier in the sampled data:
creating a rule that defines an action to be taken for a condition identified as a result of the statistical analysis; and
monitoring real-time operational data corresponding to attributes of the profile; and
when in response to the monitoring the condition is met, implementing the action identified in the rule.

16. The computer program product of claim 15, further comprising computer readable program code configured to implement:
defining a control area representing a domain of data subject to performing the statistical analysis:
determining whether the implemented action successfully met objectives set forth in the rule; and
analyzing efficacy of the rule and adjusting one or more attributes of the control area, if appropriate, based upon results of the efficacy analysis.

17. The computer program product of claim 16, further comprising computer readable program code configured to implement:
updating at least one criteria defined in the rule when it is determined that the implemented action is unsuccessful in meeting the objectives of the rule.

18. The computer program product of claim 15, further comprising computer readable program code configured to implement:
defining a control area representing a domain of data subject to performing the statistical analysis;
determining whether the condition set in the rule has been met;
analyzing efficacy of the condition and adjusting one or more attributes of the control area, if appropriate, based upon results of the efficacy analysis.

19. The computer program product of claim 15, further comprising computer readable program code configured to implement:
defining a control area representing a domain of data subject to performing the statistical analysis;
wherein the domain of data comprises historical data in a data store.

20. The computer program product of claim 15, further comprising computer readable program code configured to implement:
defining a control area representing a domain of data subject to performing the statistical analysis;
wherein the domain of data comprises a live data stream.

21. The computer program product of claim 15, wherein the rule includes a directive to generate an alert when at least one of the condition is met and the action is implemented.
